(19) United States
(12) Patent Application Publication
(10) Pub. No.: US 2008/0216628 A1
(43) Pub. Date: Sep. 11, 2008

(54) Sectioning device with adjustable cutting filament

(76) Inventor: John Michael Hamilton, Mansfield, TX (US)

Correspondence Address: Mark A. Litman & Associates, P.A.;York Business Center, Suite 205, 3209 West 76th St., Edina, MN, 55435, US

(21) Appl. No.: 11/714,563

(22) Filed: Mar. 6, 2007

(51) Int. Cl. B26D 3/24

(52) U.S. Cl. 83/581.1

(57) ABSTRACT

A tool slices or cuts baked goods or soft solid or cheesy foods into sized segments. The tool has a cutting frame and a supporting base. The frame has an open geometric cross-section structure that has multiple slicing filaments extending across an area circumscribed by the frame. At least some of the multiple slicing filaments overlap to segment the item to be cut into distinct pieces. The supporting base has a series of depressions therein that correspond to a configuration of the slicing filaments. When the cutting frame is overlaid on the supporting base, at least a portion of the filaments resides in the depressions of the supporting frame and below a supporting surface of the supporting frame to assure that individual filaments can pass completely through the items to be cut.

### BACKGROUND OF THE INVENTION

1. Field of the Invention

The present invention relates to the field of cutting devices, especially cutting or slicing devices in the food industry, and most particularly cutting or slicing devices for baked goods such as cakes and pies and pizzas.

2. Background of the Art

The present invention relates to apparatus for slicing food products into a plurality of precisely shaped pieces. More particularly, the present invention relates to an improved food slicing apparatus utilizing tensioned wire cutting elements. The apparatus is adapted for rapidly slicing flat, cylindrical food products such as pies and cakes into a plurality of neatly cut pie-shaped pieces of approximately equal size.

In the past, food slicing apparatus have existed which have used tensioned wire cutting elements. In one such apparatus adapted for slicing cheese, a single tensioned wire is spaced closely adjacent to a parallel elongate roller. The wire and the roller are mounted on the remote end of a handle. In another such apparatus also adapted for slicing cheese, a U-shaped lever is pivotably attached to a cutting board. A single tensioned wire extends between the legs of the lever. Downward swinging of the lever causes the tensioned wire to cut a slice from a block of cheese supported on the cutting board.

Other known slicing apparatus have incorporated a plurality of tensioned wires elements arranged in a predetermined array for slicing or cutting fruit, vegetables, or other food products into a plurality of uniformly dimensioned slices. For example, one such apparatus is adapted for slicing french fries from a peeled potato. It includes a square-shaped frame having a relatively large cut-out region in its center. Two perpendicular rows of spaced apart tensioned metal wire elements criss-cross the cut-out region. These wires are tightly secured at their ends to the frame. This apparatus may be forced down over the peeled potato to produce a plurality of potato segments each having a uniform cross-sectional area. Similar apparatus have also existed heretofore for cutting fruit into precise slices suitable for decorative cuisine.

A number of food products are configured in the shape of a relatively large, flat cylinder. Examples are pies and cakes, and wheels of very soft cheese such as Brie. Typically, these food products are served or divided by slicing them into a plurality of pie-shaped slices. They have a soft consistency or texture which enables them to be neatly sliced by wire cutting elements under suitable tension. It is desirable that the slices appear neatly cut. Due to the relatively high cost of such food products, it is desirable to carefully control the size and weight of individual slices. Heretofore cheesecakes and cheese wheels and other similarly shaped food products of like consistency have typically been sliced by hand using a large knife. This manual slicing process is not only time consuming but frequently results in slices in unequal size. Furthermore, in the case of pies and cakes, slices which are manually cut using a knife are often not symmetrical.

U.S. Pat. No. 4,297,932 shows an improved cheesecake cutting device comprising a two-part cutting system having an open ended cutting cylinder having a central axis, an annular wall, an upper end, a lower end, and a predetermined diameter; a plurality of wires each being longer than the predetermined diameter; a plurality of wire retaining means mounted on the cutting cylinder for securing the one ends of the wires at respective annularly spaced locations about the cutting cylinder adjacent its lower end; a plurality of adjustable tensioning means mounted on the cutting cylinder for holding the other ends of the wires so that they extend tightly across the cutting cylinder, the tensioning means being annularly spaced about the cutting cylinder adjacent the lower end thereof so that each wire extends substantially diametrically across the cutting cylinder through its central axis; a generally horizontal planar base; a pair of spaced apart vertically extending tracks mounted on the base; an open ended guide cylinder having a central axis, an annular wall, an upper end, a lower end, and a diameter substantially equal to the predetermined diameter; a yoke mounted to the guide cylinder and having side edges slidably engaged with respective ones of the tracks so that the guide cylinder can be vertically reciprocated about its central axis toward and away from the base; and releasable latch means for attaching the cutting cylinder beneath the guide cylinder with their respective central axes in substantial alignment and with the lower end of the cutting cylinder facing the planar base. This is a complex system for a simple task and requires significant and difficult cleaning operations.

U.S. Pat. No. 4,195,402 describes a dessert cutter particularly useful for delicate cakes with soft and moist composition. A frame supports a plurality of taut wires in a geometric relationship. The frame provides a grip for pressing the wires through a cake and a guide surface for visual alignment during the cutting application. The wires are supported by a gliding element that enables adjustment of the relative position of the wires along the frame.

U.S. Pat. No. 3,060,868 describes a pie cutting system comprising a container with slots down its sides and a cutting element comprising blades supported in a cylinder, with the blades fit to slide down the slots.

### SUMMARY OF THE INVENTION

A slicing or cutting tool for evenly slicing or cutting baked goods or soft solid or cheesy foods into sized segments comprises a cutting frame and a supporting base. The frame comprises a geometric cross-section support structure having multiple slicing filaments extending across an area circumscribed by the frame, with at least some of the multiple slicing filaments overlapping to segment the item to be cut into distinct pieces. The supporting base has a series of depressions therein that correspond to a configuration of the slicing filaments. When the cutting frame is overlaid on the supporting base, at least a portion of the filaments resides in the depressions of the supporting frame and below a supporting surface of the supporting frame to assure that individual filaments can pass completely through the items to be cut.

### BRIEF DESCRIPTION OF THE FIGURES

FIG. 1 shows a top view of a cutting element used in the practice of the present technology.

FIG. 2 shows a top view of a supporting element used in the practice of the present technology.

FIG. 3 shows a cutaway view of a cross-section of a groove in a supporting element, with a filament in the groove used in the practice of the present technology.

FIG. 4 shows a cross-section of an adjustable filament system that may be used in the present technology.

### DETAILED DESCRIPTION OF THE INVENTION

A slicing or cutting tool evenly slices or cuts baked goods or soft solid or cheesy foods into sized segments. The tool comprises two pieces, a supporting base and a slicing overlay or cutting frame. The slicing overlay or frame comprises a geometric cross-section support structure having multiple slicing filaments extending across an area circumscribed by the frame, with at least some of the multiple slicing filaments overlapping to segment the item to be cut into distinct pieces. By geometric it is meant that the sides of the frame define a central area that is of a geometric shape, either a regular geometric shape (e.g., circle, oval, square, rectangle, etc.) or irregular geometric shape (e.g., with both acute and obtuse angles between portions of sides. Geometric shapes with inwardly facing radii in their curvature and linear shapes with at least ninety degree angles are generally preferred shapes.

The supporting base has a series of depressions or grooves therein that correspond to a configuration of the slicing filaments. When the cutting frame is overlaid on the supporting base, at least a portion of the filaments resides in the depressions of the supporting frame and below a supporting surface of the supporting frame to assure that individual filaments can pass completely through the items to be cut.

The filaments are associated with the frame to maintain a desirable level of tension in the filaments. The tension in the filaments may be adjustable by filament tensioning and/or filaments locking systems. When using polymeric filament, this last feature becomes important as polymeric filaments (e.g., polyamide, polyester, polyethylene, etc.) tend to inelastically stretch or wear out over time, and the tension must be maintained to prevent inefficient slicing or shifting alignment of overlapping filaments. These and other features will be shown and described by reference to the figures.

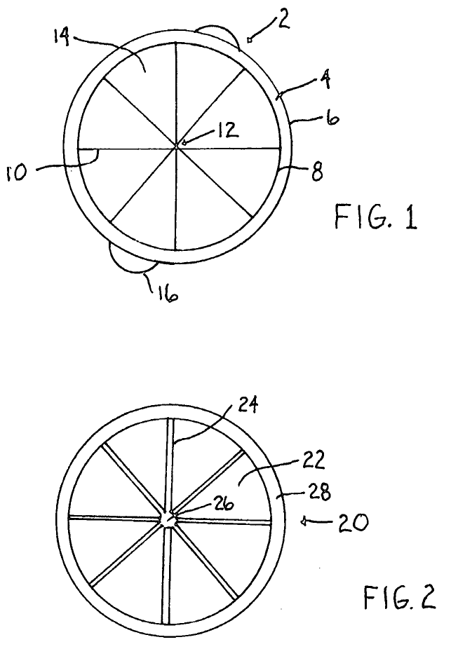

FIG. 1 shows the cutting element 2 comprising a frame 4, having an outer edge 6 and an inner edge 8. Multiple filaments 10 extend across the inner edge 8 and intersect at an approximately central point 12 to form distinct segmenting areas 14. Handles 16 may be provided on the outer edge 6 of the frame 4 to assist the user.

FIG. 2 shows a supporting element 20 having grooves or depressions 24 that traverse an exterior radial structural section 28 and form a central depression or indentation 16 that may accommodate the crossing point 12 of filaments 10 from FIG. 1. In this manner, the supporting surfaces 22 that support the item to be sliced or cut allows the filaments to pass below the lowest supported plane of the supporting surface 22 to assure a complete through cut.

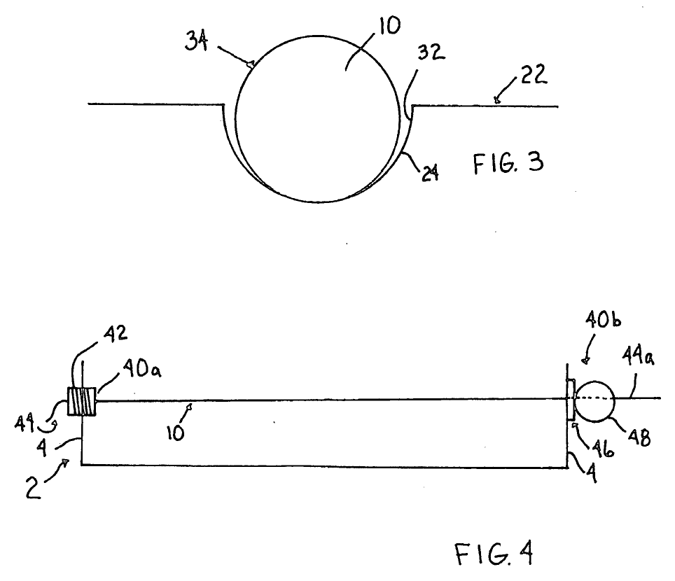

FIG. 3 shows the groove 24 and the supporting surface 22 from FIG. 2, with a filament 10 extending below the highest portions of the support surface 22. It is in this manner that the filament 10 can be assure to pass through any item to be cut and to press against the interior walls 32 of the groove or depression 24. A portion 34 of the filament may remain above the support surface 22 as shown herein, or the depth of the groove may preferably sufficiently deep to accommodate the entire cross-section of the filament 10.

FIG. 4 shows a cutaway side view of the cutting element 2 with a single filament 10 shown. The single filament 10 is shown supported on both sides of the frame by examples of various tensioning elements 40a and 40b. Different tensioning functions are shown for purely illustrative purposes, although the same type of elements may be used on both sides. Tensioning element 40a has the filament 10 secured thereto and the filament end 44 may be prevented from slipping by a knot, clip or other engaging function. The tensioning element 40a has screw threads 42 thereon to allow the tension to be adjusted by altering the depth of penetration of the tensioning element 40a (and the point of attachment of the filament 10) into the side of the frame 4. A different tensioning element 40b is shown comprising a support plate 46 against a side of the frame 4 and a slip ball 48 through which an end 44a of the filament 10 may be pulled and secured to provide tension adjustment to the filament 10. The plate 46 is optional in this construction, but assists in preventing denting of the sides by the tensioning ball 48. Any other format of providing tension in the filament and enabling that tension to be secured during use is functional. Even a system such as the ball system of 44a may be used where tension is applied by grasping the balls during cutting. This would enable tensioning of at most two filaments at any time by this method, however. The filaments should be positioned on the frame at a relative height or distance from the leading edge (moving towards the item to be cut) to enable the filaments to pass all the way into the grooves.

The technology described herein also comprises a method for slicing an item using a system for slicing items into segments of predetermined relative sizes. The system may have a support surface for the item to be sliced; and a hand held cutting frame. The hand held cutting frame has a distribution of multiple filaments extending across a central area of the frame that will overlie the item to be sliced, at least two of the multiple filaments overlapping each other within the central area to form a distribution. The support surface has depressions therein that match the distribution of the multiple filaments, including a depression corresponding to a point where the at least two multiple filaments overlap. The method includes adjusting tension in at least one of the multiple filaments without removing the at least one filament entirely from the cutting frame. That is, at least one end of the filament remains attached or connected (e.g., it may be drawn through a hole from a source of filament length, but there remains some contact, direct or indirect, with the frame). A user presses opposed sides of the system to force the multiple filaments through the item to slice the item. The tension in the filaments is sufficient that residual tension in the multiple filaments, after the cutting frame (e.g., the lowest surface of the frame) has contacted the support surface, will cause the multiple filaments to pass through a bottom-most surface in the item to be sliced. This can be easily accomplished on a consistent basis by assuring sufficient tension before the device is pressed into the item, such as cake, stiff pudding, pie, and the like. Each filament may have at least one tension adjustment connection at the sides of the frame for increasing or decreasing tension in filaments across the central area, and at least one tension adjustment connection on each of the multiple filaments is adjusted after slicing an item. The filaments may particularly comprise metal or polymeric filament. The tension may be adjusted by a step of advancing a thread on a filament support element to provide tension on at least one filament. As the element is turned, the thread moves the element further from a central area of the frame, applying tension to the filament. The method may also be practiced by having the tension adjusted in at least one of the multiple filaments by drawing the at least one filament through a filament support element (e.g., pulling it by hand) and grasping (by a screw perpendicular to the filament or by a knot) an extended position along the drawn at least one filament to retain tension in the at least one filament. This is particularly useful when providing polymeric threads which have a greater tendency to become stretched (exceed their elastic limit of deformation) more readily than metal filaments, and which display reduced filament tension more rapidly than metal filaments, which may also eventually exceed their elastic limits of deformation upon repeated application of tension that stretches the filaments. The method therefore also includes the at least one filament being a polymeric or metal filament that has exceeded its elastic limit of deformation along at least a portion of a length of the filament. The entire length of the filament may not have exceeded the elastic limit, but if that has occurred, tension becomes lost in the filament even more rapidly with use. The extension of the filament may therefore preferably require that all sections of a filament where the elastic limit has been exceeded are removed from within the center of the frame, between two opposed (on the same filament) tension adjusting or filament securing elements.

Although the figures show specific examples, these are intended to be only nonlimiting examples of the generic concepts contemplated in the practice of this technology. The frames and support may be made of plastic, metal or composite, for example, The grooves and filaments may vary in dimensions according to need. The shape and spacing of the frame may vary, as indicated above, for any geometric shape and portioning. The technology of the prior art, such as the sliding adjustability of the filament supports (still incorporating tension adjustment as taught herein) may also be used.

What is claimed:

1. A system for slicing items into segments of predetermined relative sizes comprising:
a support surface for the item to be sliced; and
a hand held cutting frame;
the hand held cutting frame having a distribution of multiple filaments extending across a central area of the frame that will overlie the item to be sliced, at least two of the multiple filaments overlapping each other within the central area to form a distribution;
the support surface having depressions therein that match the distribution of the multiple filaments, including a depression corresponding to a point where the at least two multiple filaments overlap.

2. The system of claim 1 wherein the cutting frame is circular in cross-section.

3. The system of claim 1 wherein the cutting frame is rectangular in cross-section.

4. The system of claim 1 wherein each filament has at least one tension adjustment connection at the sides of the frame for increasing or decreasing tension in filaments across the central area.

5. The system of claim 1 wherein each filament has two tension adjustment connections at each side of the frame for increasing or decreasing tension in filaments across the central area.

6. The system of claim 4 wherein the tension adjustment connection comprises a screw driven element connected to a filament.

7. The system of claim 4 wherein the tension adjustment connection comprises a ball having a central hole therethrough which allows a filament to pass through the hole.

8. The system of claim 1 wherein the filaments are selected from the group consisting of polymers and metals.

9. A method for slicing an item using an apparatus comprising a system for slicing items into segments of predetermined relative sizes comprising:
a support surface for the item to be sliced; and
a hand held cutting frame;
the hand held cutting frame having a distribution of multiple filaments extending across a central area of the frame that will overlie the item to be sliced, at least two of the multiple filaments overlapping each other within the central area to form a distribution; the support surface having depressions therein that match the distribution of the multiple filaments, including a depression corresponding to a point where the at least two multiple filaments overlap;
the method comprising adjusting tension in at least one of the multiple filaments without removing the at least one filament entirely from the cutting frame, pressing opposed sides of the system to force the multiple filaments through the item to slice the item, the tension in the filaments being sufficient that residual tension in the multiple filaments after the cutting frame has contacted the support surface will cause the multiple filaments to pass through a bottom-most surface in the item to be sliced.

10. The method of claim 9 wherein each filament has at least one tension adjustment connection at the sides of the frame for increasing or decreasing tension in filaments across the central area, and at least one tension adjustment connection on each of the multiple filaments is adjusted after slicing an item.

11. The method of claim 10 wherein the filaments comprise metal or polymeric filament.

12. The method of claim 9 wherein tension is adjusted by a step comprising advancing a thread on a filament support element to provide tension on at least one filament.

13. The method of claim 9 wherein tension is adjusted in at least one of the multiple filaments by a step comprising drawing the at least one filament through a filament support element and grasping an extended position along the drawn at least one filament to retain tension in the at least one filament.

14. The method of claim 13 wherein the at least one filament comprises a polymeric filament that has exceeded its elastic limit of deformation along at least a portion of a length of the filament.
